(19) United States
(12) Patent Application Publication
(10) Pub. No.: US 2013/0003424 A1
(43) Pub. Date: Jan. 3, 2013

(54) MULTI-PHASE INTERLEAVED BIDIRECTIONAL DC-DC CONVERTER WITH HIGH VOLTAGE CONVERSION RATIO

(76) Inventors: Yujin Song, Daejeon-si (KR); Soo-Bin Han, Daejeon-si (KR); Sukin Park, Daejeon-si (KR); Hak-Geun Jeong, Daejeon-si (KR); Su-Yong Chae, Daejeon-si (KR); Gyu-Duk Kim, Daejeon-si (KR); Seung-Weon Yu, Daejeon-si (KR)

(21) Appl. No.: 13/282,127

(22) Filed: Oct. 26, 2011

(30) Foreign Application Priority Data
Jun. 29, 2011 (KR) 10-2011-0063735

(51) Int. Cl. H02M 3/335

(52) U.S. Cl. 363/21.04

(57) ABSTRACT

A multi-phase interleaved bidirectional DC-DC converter with a high voltage conversion ratio is provided. The multi-phase interleaved bidirectional DC-DC converter with a high voltage conversion ratio allows effective control of charge/discharge in multi-energy storage modules including a battery cell module or a super capacitor module, which is characterized in low voltage and high current output. Accordingly, a high-efficiency bidirectional DC-DC converter for use in battery charge/discharge can be implemented.

### CROSS-REFERENCE TO RELATED APPLICATION(S)

This application claims priority from and the benefit under 35 U.S.C. §119(a) of Korean Patent Application No. 10-2011-0063735, filed on Jun. 29, 2011, in the Korean Intellectual Property Office, which is herby incorporated by reference for all purposes as is fully set forth herein.

### BACKGROUND

1. Field

The following description relates to a multi-phase interleaved bidirectional DC-DC converter with a high voltage conversion ratio.

2. Description of Related Art

In recent years, active introduction of new renewable energy has increased in the developed countries as a solution for global warming and the depletion of fossil energy. However, new renewable energy, such as wind power or photovoltaic, greatly depends on climatic and geographical environments due to its intermittent output characteristics and accordingly has difficulties in predicting the generation amount of energy. Because of these characteristics, distributed generation system using renewable energy may cause instability of power grid and degradation of power quality.

Meanwhile, the output fluctuation of renewable energy can be reduced by a grid stabilization system with energy storage, such as battery and super capacitor, through parallel operation with a distributed generation system.

Accordingly, there is a need for a large-capacity bidirectional DC-DC converter with a high voltage conversion ratio which can control charge or discharge of a low-voltage battery.

### SUMMARY

Exemplary embodiments of the present invention provide a multi-phase interleaved bidirectional DC-DC converter with a high voltage conversion ratio allowing effective control of charge/discharge in multi-energy storage modules including battery cell modules or super capacitor modules, which are characterized in low-voltage and high-current output.

Additional features of the invention will be set forth in the description which follows, and in part will be apparent from the description, or may be learned by practice of the invention.

Exemplary embodiments of the present invention provide a multi-phase interleaved bidirectional DC-DC converter with a high voltage conversion ratio, including: a first input/output unit configured to comprise a single chargeable or dischargeable energy storage component and a plurality of inductors and to input a current or output a voltage, wherein the inductors are connected in parallel to one another and store a current produced by the energy storage component; a plurality of first half-bridges configured to control currents input from the respective inductors of the first input/output unit or voltages output to the respective inductors, wherein the number of the first half-bridges is the same as the number of the inductors; a single second input/output unit configured to input a single current or output a single voltage; a plurality of second half-bridges configured to control a current input from the second input/output unit or a voltage output to the second input/output unit, wherein the number of the second half-bridges is the same as the number of the first half-bridges; and a plurality of transformers configured to transform currents from the first half-bridges to the second half-bridges or currents from the second half-bridges to the first half-bridges according to buck mode or boost mode, wherein the number of the transformers is the same as the number of the first half-bridges and the number of the second half-bridges.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of is the invention.

FIG. 1 is a circuit diagram of a multi-phase interleaved bidirectional DC-DC converter with a high voltage conversion ratio according to an exemplary embodiment of the present invention.

FIG. 2 is a circuit diagram illustrating an example of a three-phase interleaved bidirectional DC-DC converter with a high voltage conversion ratio according to an exemplary embodiment of the present invention.

FIG. 3 is a diagram illustrating waveforms showing the theoretical operations of the three-phase interleaved bidirectional DC-DC converter illustrated in FIG. 2.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

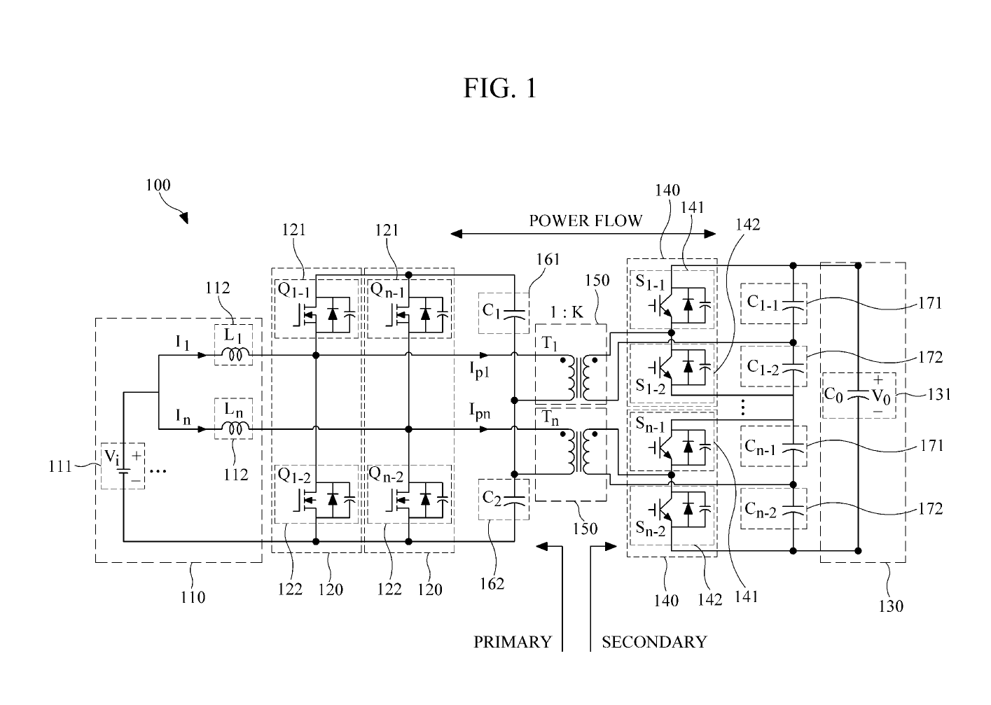

FIG. 1 is a circuit diagram of a multi-phase interleaved bidirectional DC-DC converter with a high voltage conversion ratio according to an exemplary embodiment of the present invention. As shown in FIG. 1, multi-phase interleaved bidirectional DC-DC converter 100 with a high voltage conversion ratio includes a first input/output unit 110, a plurality of first half-bridges 120, a single input/output unit 130, a plurality of second half-bridges 140, and a plurality of transformers 150, wherein the number of the second half-bridges 140 and the number of the transformers 150 are the same as the number of the first half-bridges 120.

The first input/output unit 110 may include a single chargeable/dischargeable energy storage component 111 and a plurality of inductors 122 which are connected to one another in parallel to store a current generated by the energy storage component 111. The first input/output unit 110 inputs a current or outputs a voltage.

Since the bidirectional DC-DC converter is characterized in that both input and output ends perform current input or voltage output according to buck mode or boost mode, the first input/output unit 110 receives a current in buck mode, and outputs a voltage in boost mode.

For example, the energy storage component 111 may be a battery or a super capacitor which allows charge or discharge of energy. In boost mode, each of the inductors 112 may store current from the energy storage component 111, and discharge the stored current.

The number of the first half-bridges 120 is the same as the number of the inductors 112 of the first input/output unit 110, and each of the first half-bridges 120 controls a current input from the first input/output unit 110 and a voltage output to the first input/output unit 110. The first half-bridges are connected between the first input/output unit 110 and the transformers 150, which will be described later, to allow zero voltage switching.

In this case, the first half-bridges 120 may include a plurality of switches 121 and 122. The switches 121 and 122 rectify high-frequency current pulses transformed by the transformers 150 to output a DC current to the first input/output unit 110 in buck mode, and modulate a DC current output from the first input/output unit 110 into a high-frequency current pulse and outputs the resultant high-frequency current pulses to the transformers 150 in boost mode.

Each of the first half-bridges 120 may be arranged in a primary side of the transformers 150. The switches 121 and 122 may be implemented as insulated gate bipolar transistors (IGBTs) or MOS field-effect transistors (MOSFETs).

In the multi-phase interleaved bidirectional DC-DC converter 100, the primary side of the transformers 150 has a lower voltage than the secondary side. When the multi-phase interleaved bidirectional DC-DC converter 100 is in buck mode, energy is transmitted from the secondary side having a higher voltage to the primary side having a lower voltage. When the multi-phase interleaved bidirectional DC-DC converter 100 is in boost mode, energy is transmitted from the primary side having a lower voltage to the secondary side.

The multi-phase interleaved bidirectional DC-DC converter 100 according to the current embodiment can be extended in parallel for each phase by adding a bidirectional DC-DC converter in a parallel manner according to the output capacity of the energy storage component 111. In this case, the energy storage component 111 of the first input/output unit 110 is shared.

For example, an increase in the output capacity of the energy storage component 111 may enable a single-phase bidirectional DC-DC converter module to be added. In this case, the added bidirectional DC-DC converter module may include one inverter 112 and a first half-bridge 120, wherein the inverter 112 is newly connected to the energy storage component 111 and the first half-bridge 120 includes a plurality of switches 121 and 122.

The single second input/output unit 130 may input a single current or output a single voltage. The second input/output unit 130 may include an energy storage capacitor Co 131 to store energy input from outside.

The multi-phase interleaved bidirectional DC-DC converter 100 according to the current embodiment include a single second input/output unit 130 regardless of the number of the inductors 112 of the first input/output unit 110. In boost mode, an output from the multi-phase interleaved bidirectional DC-DC converter 100 is a voltage cross the second input/output unit 130. For example, the second input/output unit 130 may be connected to a DC input terminal of a grid-connected inverter, to a DC output terminal of a distributed generation converter or to a DC input terminal of a load converter.

When the multi-phase interleaved bidirectional DC-DC converter 100 is in boost mode, energy flows from the first input/output unit 110 to the second input/output unit 130. The energy is stored in the energy storage capacitor C₀ 131 of the second input/output unit 130, and is supplied to an external power system (not illustrated) via a DC input terminal.

When the multi-phase interleaved bidirectional DC-DC converter 100 is in buck mode, energy flows from the second input/output unit 130 to the first input/output unit 110. The energy storage capacitor C₀ 131 of the second input/output unit 130 stores energy transferred from an external power system (not illustrated), and transfers the energy to the second input/output unit 130 via the second half-bridges 140 and the transformers 150.

The number of the second half-bridges 140 is the same as the number of the first half-bridges 120. The second half-bridges 140 control a current input by the second input/output unit 130 or a voltage output to the second input/output unit 130. The second half-bridges 140 are connected between the second input/output unit 130 and the transformers 150.

In buck mode, each of the second half-bridges 140 includes a plurality of switches 141 and 142 to convert a DC current input from the second input/output unit 130 into high-frequency current pulses and output the resultant pulses to the transformers 150 in buck mode, and to rectify high-frequency current pulses transformed by the transformers 150 and output a DC current to the second input/output unit 130 in boost mode.

The second half-bridges 140 are arranged in a secondary side of the transformers 150. A plurality of the switches 141 and 142 may be implemented as IGBTs or MOSFETs.

In the multi-phase interleaved bidirectional DC-DC converter 100 according to the current embodiment, the primary side of the transformers 150 has a lower voltage than the secondary side. When the multi-phase interleaved bidirectional DC-DC converter 100 is in buck mode, energy flows from the secondary side having a higher voltage to the primary side having a lower voltage, and when the multi-phase interleaved bidirectional DC-DC converter 100 is in boost mode, energy flows from the primary side to the secondary side.

The multi-phase interleaved bidirectional DC-DC converter 100 according to the current embodiment can be extended in parallel for each phase by adding a bidirectional DC-DC converter according to the output capacity of the energy storage component 111. In this case, the energy storage component 111 of the first input/output unit 110 is shared.

For example, an increase in the output capacity of the energy storage component 111 may enable a single-phase bidirectional DC-DC converter module be added. In this case, the added bidirectional DC-DC converter module may include one inverter 112, a first half-bridge 120, and a second half-bridge 140, wherein the inverter 112 is newly connected to the energy storage component 111, the first half-bridge 120 includes a plurality of switches 121 and 122 connected to the inductor 112 and the second half-bridge 140 includes a plurality of switches 141 and 142 corresponding to the respective switches 121 and 122 in the first half-bridge 120.

The number of the transformers 150 is the same as the number of the first half-bridges 120 and the number of the second half-bridges 140. The transformers 150 transform currents from the first half-bridges 120 and currents from the second half-bridges 140 according to buck mode or boost mode.

The first half-bridges 120 are connected at the primary side of the transformers 150 and the second half-bridges 140 are connected at the secondary side of the transformers 150. In boost mode, the transformers 150 transform a voltage from the primary side and apply the transformed voltage to the secondary side. In buck mode, reversely, the transformers 150 transform a voltage from the secondary side and apply the transformed voltage to the primary side. Also, the transformers 150 electrically insulate a power source and a load. The transformers 150 with a predetermined turn ratio of 1:K transform the voltages from the primary side and the secondary side.

The multi-phase interleaved bidirectional DC-DC converter 100 according to the current embodiment can be extended in parallel for each phase according to the output capacity of the s energy storage component 111. In this case, the energy storage component 111 of the first input/output unit 110 is shared.

For example, an increase in the output capacity of the energy storage component 111 may enable a single-phase bidirectional DC-DC converter module to be added. In this case, the added bidirectional DC-DC converter module may include one inverter 112, a first half-bridge 120, a second half-bridge 140, and a transformer 150, wherein the inverter 112 is newly connected to the energy storage component 111, the first half-bridge 120 includes a plurality of switches 121 and 122 connected to the inductor 112, the second half-bridge 140 includes a plurality of switches 141 and 142 corresponding to the respective switches 121 and 122 in the first half-bridge 120 and the transformer 150 is connected to the second half-bridge 140.

According to another aspect of the present invention, the multi-phase interleaved bidirectional DC-DC converter 100 may further include a plurality of lossless capacitors 161 and 162. The lossless capacitors 161 and 162 are connected in common to a plurality of the first half-bridges 120, and are, respectively, connected to the switches 121 and 122 in each first half-bridge 120. The lossless capacitors 161 and 162 are used for soft switching implementation.

According to another aspect of the present invention, the multi-phase interleaved bidirectional DC-DC converter 100 may further include a plurality of lossless capacitors 171 and 172. The lossless capacitors 171 and 172, provided for each of the second half-bridges 140, are, respectively, connected to the switches 141 and 142 in each second half-bridge 140. The lossless capacitors 171 and 172 are used for soft switching implementation.

A connection between each elements of the multi-phase interleaved bidirectional DC-DC converter 100 with a high voltage conversion ratio according to an exemplary embodiment will be described in detail with reference to FIG. 1 again. N-phase interleaved bidirectional DC-DC s converter with a high voltage conversion ratio includes a first input/output unit 110 which is formed by connecting a plurality of inductors L₁, . . . , Lₙ 112 to the energy storage component Vi 111 wherein the inductors are connected in parallel to one another.

The inductors 112 of the first input/output unit 110 are connected to the respective first half-bridges 120. Each of the first half-bridges 120 includes a plurality of the switches 121 and 122 which are connected in parallel to both ends of the common energy storage component 111 and both ends of each of the transformers 150. Also, the switches 121 and 122 of each of the first half-bridges 120 are, respectively, connected in parallel to a plurality of the lossless capacitors 161 and 162, which are shared with the first half-bridges 120.

When the multi-phase interleaved bidirectional DC-DC converter 100 with a high voltage conversion ratio is extended in parallel for each phase as an output capacity of the energy storage component 111 increases, an inductor 112 and a first half-bridge 120 connected to the inductor 112 may be added. In this case, only a plurality of switches 121 and 122 that constitute the first half-bridge may be added, and a plurality of the lossless capacitors 161 and 162 are shared with the existing first half-bridges and the added first half-bridge.

The number of the transformers T₁, . . . , Tₙ 150 is the same as the number of the inductors 112 of the first input/output unit 110. The transformers T₁, . . . , Tₙ 150 are high-frequency transformers. The transformers 150 are connected to the respective first half-bridges 120 in the primary side and the respective second half-bridges 140 in the secondary side with Y-Y connection.

One end at the primary side of each of the transformers 150 is connected to a contact point between corresponding switches Q₁₋₁, Q₁₋₂, . . . , Qₙ₋₁, and Qₙ₋₂ 121 and 122 included in each of the first half-bridges 120, and the other end at the primary side of each of the transformers 150 is connected to a contact point between the lossless capacitors C₁ and C₂ 161 and 162 shared with the first half-bridges 120.

One end at the secondary side of each of the transformers 150 is connected to a contact point between the switches S₁₋₁, S₁₋₂, . . . , Sₙ₋₁ and Sₙ₋₂ 141 and 142, and the other end at the second side of each of the transformers 150 is connected in parallel to a contact point between the lossless capacitors C₁₋₁,C₁₋₂, . . . , Cₙ₋₁,and Cₙ₋₂ 171 and 172 which are respectively connected in parallel to the switches 141 and 142 of each of the second half-bridges 140.

An increase in an output capacity of the energy storage component 111 of the multi-phase interleaved bidirectional DC-DC converter 100 may enable a single-phase bidirectional DC-DC converter module, and each time of addition, a second half-bridge 140 may be added. In this case, a plurality of lossless capacitors 171 and 172 are added to be, respectively, connected in parallel to a plurality of switches 141 and 142 of the second half bridge 140. The second half-bridge 140 is connected to the energy storage capacitor C₀ 131 of the second input/output unit 130.

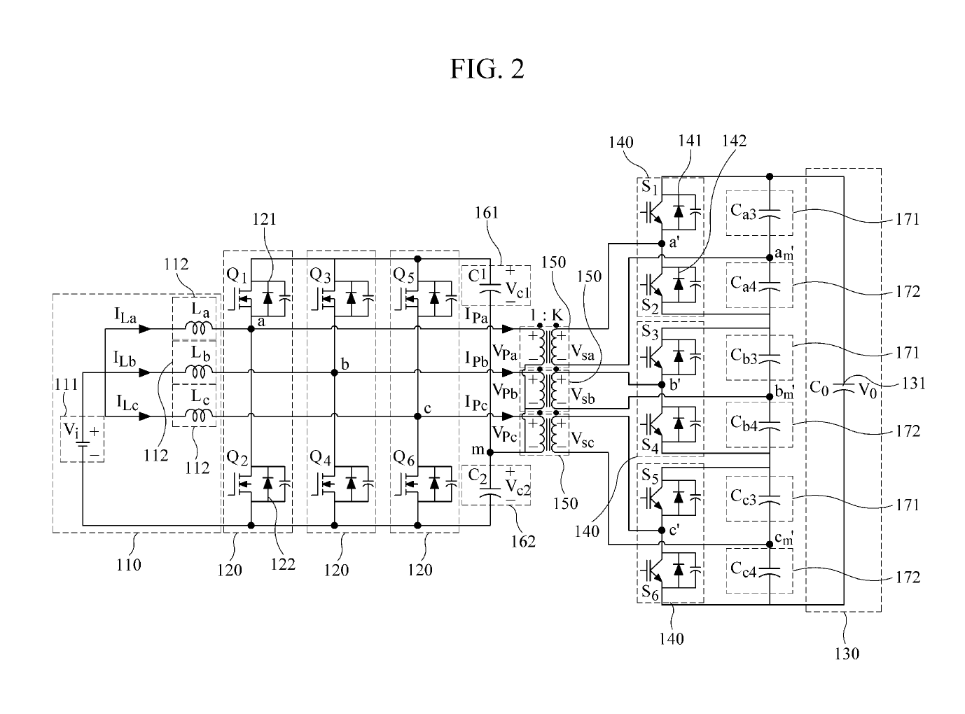

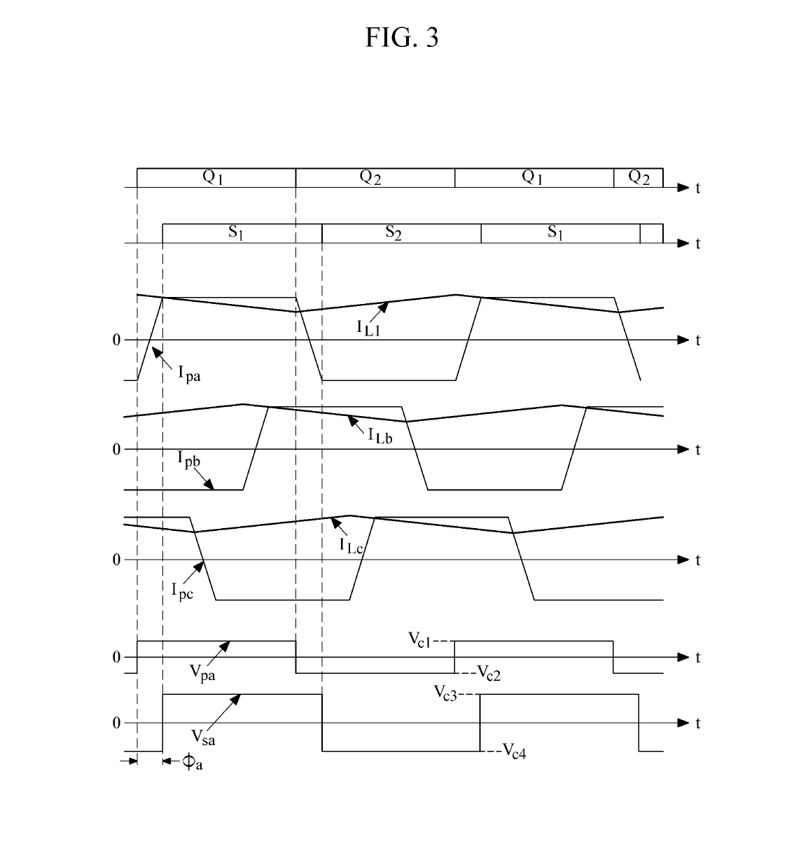

FIG. 2 is a circuit diagram illustrating an example of a three-phase interleaved bidirectional DC-DC converter with a high voltage conversion ratio according to an exemplary embodiment of the present invention. FIG. 3 is a diagram illustrating waveforms showing the theoretical operations of the three-phase interleaved bidirectional DC-DC converter illustrated in FIG. 2.

The three-phase interleaved bidirectional DC-DC converter with a high voltage conversion ratio includes three-phase high frequency transformers 150 connected to both a primary side and a secondary side with Y-Y connection. At the primary side of the three-phase high frequency transformer 150, three inductors Lₐ, L_{b}, and L_{C} 112 and three first half-bridges 120 are arranged. The first half-bridges 120 includes a plurality of switches Q₁ and Q₂, Q₃ and Q₄, and Q₅ and Q₆ 121 and 122, respectively, and share a plurality of lossless capacitors C₁ 161 and C₂ 162.

One ends at the primary side of the three-phase high frequency transformers 150 are, respectively, connected to contact points a, b, and c between the switches 121 and 122 of the respective first half-bridges 120. The other ends at the primary side of the transformers 150 are connected in common to a contact point m between the lossless capacitors 161 and 162.

In addition, at a secondary side of the three-phase high frequency transformers 150, three second half-bridges 140 and an energy storage capacitor C₀ 131 are arranged. The second half-bridges 140, respectively, include a plurality of switches S₁ and S₂, S₃ and S₄, S₅ and S₆ 141 and 142, and the switches S₁ and S₂, S₃ and S₄, S₅ and S₆ 141 and 142 of the respective second half-bridges 140 are connected to a plurality of lossless capacitors Cₐ₃ and Cₐ₄, C_{b3} and C_{b4}, and C_{c3} and C_{c4} 171 and 172, respectively.

One ends at the secondary side of the three-phase high frequency transformers 150 are, respectively, connected to contact points a′, b′, and c′ between the switches 141 and 142. In addition, the other ends at the secondary side of the three-phase high frequency transformers 150 are, respectively, connected to contact points aₘ′, bₘ′, and cₘ′ between the lossless capacitors 171 and 172 which are connected to the switches 141 and 142 of the respective second half-bridges 140.

Referring to FIG. 3, if a multi-phase interleaved bidirectional DC-DC converter 100 with a high voltage conversion ratio includes an a-phase energy storage module Vₐ, there is a difference in a turn-on time between the switches 121 and 122 of the first half-bridge 120 and the switches 141 and 142 of the second half-bridge 140.

I_{La}, I_{Lb}, and I_{Lc} represent inductor input currents flowing, respectively, through a-, b-, and c-phase inductors Lₐ, L_{b}, and L_{c} 110. Iₚₐ, I_{pb}, and I_{pc} represent primary currents of the transformers 150. Vₚₐ represents an a-phase primary pulse voltage, and Vₛₐ represents an a-phase secondary pulse voltage. V_{c1} represents a voltage across the lossless capacitor C₁, and V_{c2} represents a voltage across the lossless capacitor C₂.

There is a phase shift φa between the a-phase primary square wave voltage and the a-phase secondary square wave voltage of the transformer 150. The phase shift determines the amount of power to be transmitted through the multi-phase interleaved bidirectional DC-DC converter with a high voltage conversion ratio. Each-phase first half-bridge 120 and each-phase second half-bridge 140 operate at a duty ratio of 50%.

As illustrated in the above examples, it is possible for a multi-phase interleaved bidirectional DC-DC converter with a high voltage conversion ratio to effectively control charge or discharge of energy in an energy storage device such as a battery or a super capacitor which is characterized in low-voltage and high-current output.

In addition, it is possible to boost a voltage with a high voltage conversion ratio using transformers with a low turn ratio since the multi-phase interleaved bidirectional DC-DC converter with a high voltage conversion ratio according to the exemplary embodiments of the present invention is a current-fed half-bridge DC-DC converter.

Further, the multi-phase interleaved bidirectional DC-DC converter with a high voltage conversion ratio enables zero voltage switching on both primary and secondary sides of the transformers, thereby minimizing a switching loss. Also, by operating a plurality of bidirectional DC-DC converters concurrently and in parallel, conduction loss in each element of the converters can be minimized and thus it is possible to implement a high-efficiency bidirectional

DC-DC converter for batter charge/discharge.

Further, the multi-phase interleaved bidirectional DC-DC converter with a high voltage conversion ratio according to the exemplary embodiments of the present invention can be extended in parallel for each phase by adding a bidirectional DC-DC converter according to a capacity of an energy storage device, and charge/discharge current riffle in the energy storage device can be minimized through interleaved parallel operation of the bidirectional DC-DC converters.

Furthermore, according to the exemplary embodiments of the present invention, the multi-phase interleaved bidirectional DC-DC converter with a high voltage conversion ratio as a current-fed DC-DC converter does not require a voltage clamping circuit, resulting in reduction of manufacturing costs.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A multi-phase interleaved bidirectional DC-DC converter with a high voltage conversion ratio, comprising:
a first input/output unit configured to comprise a single chargeable or dischargeable energy storage component and a plurality of inductors and to input a current or output a voltage, wherein the inductors are connected in parallel to one another and store a current produced by the energy storage component;
a plurality of first half-bridges configured to control currents input from the respective inductors of the first input/output unit or voltages output to the respective inductors, wherein the number of the first half-bridges is the same as the number of the inductors;
a single second input/output unit configured to input a single current or output a single voltage;
a plurality of second half-bridges configured to control a current input from the second input/output unit or a voltage output to the second input/output unit, wherein the number of the second half-bridges is the same as the number of the first half-bridges; and
a plurality of transformers configured to transform currents from the first half-bridges to the second half-bridges or currents from the second half-bridges to the first half-bridges according to buck mode or boost mode, wherein the number of the transformers is the same as the number of the first half-bridges and the number of the second half-bridges.

2. The multi-phase interleaved bidirectional DC-DC converter with a high voltage conversion ratio of claim 1, wherein each of a plurality of the first half-bridges is further configured to comprise a plurality of switches configured to rectify high frequency current pulses transformed by the transformers and output a DC current to the first input/output unit in buck mode, and to modulate a DC current output from the first input/output unit into high frequency current pulses and output the resultant pulses to the transformers.

3. The multi-phase interleaved bidirectional DC-DC converter with a high voltage conversion ratio of claim 1, wherein each of a plurality of the second half-bridges is further configured to comprise a plurality of switches configured to convert a DC current input from the second input/output unit into high frequency current pulses and output the resultant pulses to the transformers in buck mode and to rectify high frequency current pulses transformed by the transformers and output a DC current to the second input/output unit.

4. The multi-phase interleaved bidirectional DC-DC converter with a high voltage conversion ratio of claim 2, further comprising:
a plurality of lossless capacitors configured to be shared by the first half-bridges and be connected, respectively, to the switches of the first half bridges for use in soft switching implementation.

5. The multi-phase interleaved bidirectional DC-DC converter with a high voltage conversion ratio of claim 3, further comprising:
a plurality of lossless capacitors configured to be provided for the respective second half-bridges and be connected to the respective switches of each of a plurality of the second half-bridges for use in soft switching implementation.

6. The multi-phase interleaved bidirectional DC-DC converter with a high voltage conversion ratio of claim 1, wherein the second input/output unit is further configured to comprise an energy storage capacitor to store energy input from outside.
